(19) United States
(12) Patent Application Publication
(10) Pub. No.: US 2006/0256821 A1
(43) Pub. Date: Nov. 16, 2006

(54) Signal synchronization in display systems

(76) Inventor: Peter Richards, San Francisco, CA (US)

Correspondence Address: TEXAS INSTRUMENTS INCORPORATED, P O BOX 655474, M/S 3999, DALLAS, TX, 75265, US

(21) Appl. No.: 11/128,607

(22) Filed: May 13, 2005

(51) Int. Cl. H04J 3/06

(52) U.S. Cl. 370/503

(57) ABSTRACT

The present invention discloses a synchronization method that synchronized the operations of the functional modules with the source signal to be processed. The synchronization is achieved through an intermediate reference signal generated form a master synchronization module. The intermediate reference signal is synchronized to the source signal, while the operations of the functional modules are synchronized with the intermediate reference signal. In this way, the operations of the functional modules can be successfully isolated from the source signal to be processed. In an embodiment of the invention, the synchronization uses interrupt signals.

### CROSS-REFERENCE TO RELATED ARTS

The subject matter of each of the following patents and patent applications are incorporated herein by reference in their entirety.

| Serial/Patent Number | Filling/Issue Date | Attorney docket number |
|---|---|---|
| 09/564,069 | May 3, 2000 | P10-US |
| 10/340,162 | Jan. 10, 2003 | P71-US |
| 10/407,061 | Apr. 2, 2003 | P88-US |
| 10/607,687 | Jun. 23, 2003 | P103-US |
| 10/648,608 | Aug. 25, 2003 | P104-US |
| 10/648,689 | Aug. 25, 2003 | P105-US |
| 10/698,290 | Oct. 30, 2003 | P123-US |
| 10/751,145 | Jan. 2, 2004 | P133-US |
| 10/865,993 | Jun. 11, 2004 | P155-US |
| 5,835,256 | Nov. 10, 2003 | P1-US |
| 09/767,632 | Jan. 22, 2001 | P108-US |
| 10/437,776 | May 13, 2003 | P110-US |
| 10/698,563 | Oct. 30, 2003 | P113-US |
| 10/982,259 | Nov. 5, 2004 | P174-US |

### TECHNICAL FIELD OF THE INVENTION

The present invention is related generally to the art of signal synchronization in display systems, and more particular to signal synchronization in digital display systems employing spatial light modulators and color wheels.

### BACKGROUND OF THE INVENTION

Signal synchronization is a crucial issue in signal processes. In a signal processing system having a functional module for processing an external or internal source signal to be processed, operations of the functional module are often required to be synchronized with the source signal.

As a way of example, a digital display system is a system that reproduces video according to a sequence of video signals. Such a system often comprises a set of functional modules, such as a light source producing a light beam, color filter that extracts monochromatic colors from the light beam, and image engine (e.g. a LCD, LCOS, CCD or micromirror spatial light modulator) for modulating the monochromatic colors, to accomplish the display task. Operations of the color filter, the lamp, and modulation of the image engine are required to be synchronized to the video signals so as to achieve a successful display application.

Therefore, what is needed is a method for synchronizing the operations of the system.

### SUMMARY OF THE INVENTION

In view of the foregoing, the present invention discloses a synchronization method that synchronizes the operations of the functional modules with the source signal to be processed. The synchronization is achieved through an intermediate reference signal generated form a master synchronization module. The intermediate reference signal is synchronized to the source signal, while the operations of the functional modules are synchronized with the intermediate reference signal. In this way, the operations of the functional modules can be successfully isolated from the source signal to be processed. In an embodiment of the invention, the synchronization uses interrupt signals.

The synchronization is accomplished through multiple synchronization routines depending upon the phase-differences between the source signal and the signal to be synchronized with the source signal (hereafter, refer to as target signal). Specifically, when the phase-difference is small (according to a predefined criterion), the target signal is synchronized with the source signal by converging the target signal to the source signal using proportional feedback. After the convergence, the occurrence of the next target signal is synchronized with the occurrence of the next source signal. When the phase-difference is not small, the target signal is linearly converged to the source signal until the phase-difference is small.

As an exemplary application of the embodiment in a display system employing a set of functional modules comprising a light source, a color wheel that is driven by a motor, and a spatial light modulator, operations of the functional modules are synchronized with the source video signal of a video to be produced by the system. The synchronization is accomplished by using interrupt signals one of which is a reference synchronization interrupt M_{sync} from a master synchronization module. The M_{sync} is synchronized to the video signals V_{sync}. A set of interrupt signals comprising a motor control interrupt signal Motor_{sync} and PWM sequencer interrupt signal SEQ_{sync} are synchronized to the reference synchronization signal M_{sync}. The Motor_{sync} results in another synchronization signal Motor_PWM_{syn} that instructs a motor PWM module to generate a trigger signal with which the motor for driving the color wheel is operated.

The objects of the invention are achieved in the features of the independent claims attached hereto. Preferred embodiments are characterized in the dependent claims.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1 is a flow chart showing the steps executed in synchronizing the operations of a signal processing system to a source signal;

FIG. 2 schematically illustrates a train of signals is synchronized with a sequence of source signals according to an embodiment of the invention;

FIG. 3 schematically illustrates another train of signals is synchronized with a sequence of source signals according to another embodiment of the invention;

FIG. 4 schematically illustrates convergence processes used in synchronizing reference signals to source signals;

FIG. 5 illustrates a display system in which embodiment of the invention can be implemented;

FIG. 6 schematically illustrates the interrupt handlers for performing the synchronization in the display system in FIG. 4;

FIG. 7 is a flow chart showing the steps executed by the V-sync module in FIG. 5;

FIG. 8 is a flow chart showing the steps executed by the Motor control sync module in FIG. 5;

FIG. 9 is a flow chart showing the steps executed by the master module in FIG. 5;

FIG. 10 is a flow chart showing the steps executed by the sequencer module in FIG. 5;

FIG. 11 is a flow chart showing the steps executed by the lamp sync module in FIG. 5;

FIG. 12 is a flow chart showing the steps executed by the motor PWM module in FIG. 5; and

FIG. 13 is an exemplary spatial light modulator of FIG. 1.

### DETAILED DESCRIPTION OF THE EMBODIMENTS

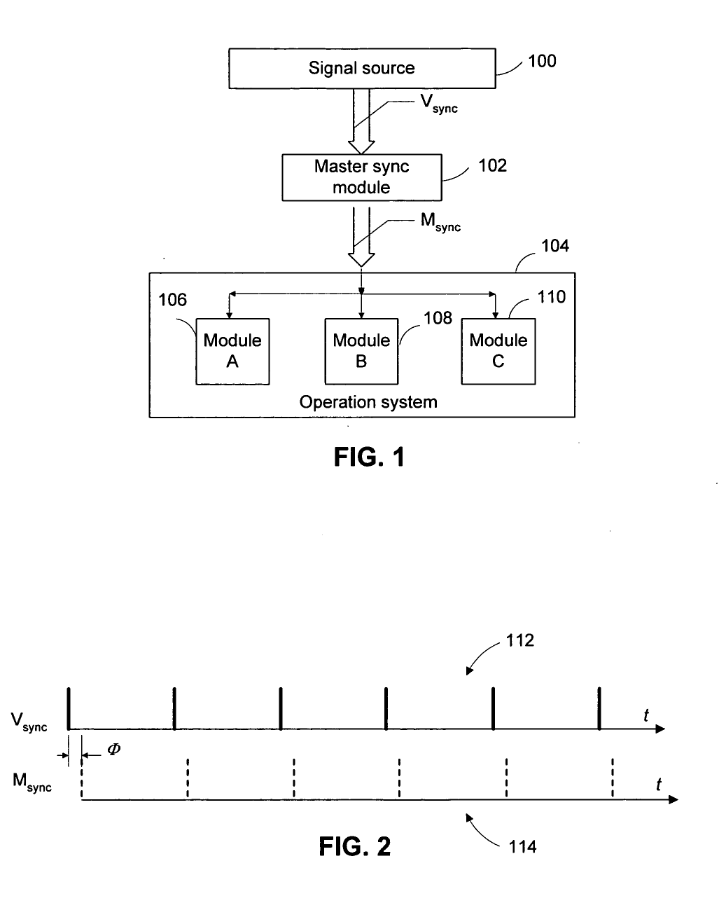

Turning to the drawings, FIG. 1 is a flow chart showing the steps executed in synchronizing a functional module of a system to a source signal. In this demonstrative example, system 104 comprises functional modules A 106, B 108, and C 110. Operations of the functional modules are relevant to source signal 100, and need to be synchronized to the source signal. Master sync module 102 is provided to coordinate the synchronization between the functional modules A, B, and C and the source signal. The master sync module can be separated from system 104, or alternatively can be a member of system 104.

In operation, source signal module 100 releases a sequence of source signals that comprise a synchronization signal component V_{sync}. The source signals are delivered to the system, and the source synchronization signal V_{sync} is captured and extracted by master sync module 102. Master sync module 102 generates a sequence of reference synchronization signals M_{sync} and synchronizes the M_{sync} to the source signal V_{sync}. The M_{sync} signal is then transmitted to functional modules A, B, and C. Upon receiving the synchronization signal M_{sync} and the source signals, the functional modules A, B, and C synchronize their operations to M_{sync} and operate accordingly. In this way, synchronizations of the functional modules A, B, and C to the source signals are isolated by master sync module. Such isolation provides much more freedom to the functional modules of the system in accommodating different and complex source signals, especially unstable signals and missing signals, and their individual operations.

The synchronization between the reference synchronization signals M_{sync} from master sync module 102 and the source signals V_{sync} can be accomplished in many ways. According to the invention, the synchronization process can be mathematically expressed as:

$${M}_{sync} ( i + 1 ) = {M}_{sync} ( i ) + \frac{N}{D} T + fun ( T , Φ ) \qquad ( Eq . 1 )$$

wherein M_{sync}(i) is the timestamp of a reference synchronization signal event in the past, M_{sync}(i+1) is the timestamp of the scheduled next reference synchronization signal event, and Φ is the phase-difference between M_{sync}(i) and V_{sync}(i). The ratio of N/D represents the ratio of the periods of the source signals V_{sync} and reference signals M_{sync}. For example, the period of the source signals can be 1/60 Hz, while the reference signals can be 1/120 Hz, or any periods. fun(T, Φ) is an error correction function of the V_{sync} period T and initial phase-difference Φ. The form of this function is determined based upon the current status of the V_{sync} and M_{sync}. Specifically, for the phase-differences Φ of different magnitudes, the form of function fun(T, Φ) can be linear and/or non-linear functions of T and/or Φ. The response of the synchronization—that is the phase-difference between the reference and source signals can be converged linearly or non-linearly over time. In the following, a linear and non-liner phase convergence schemes will be discussed. It will be understood that the following examples are for demonstration purposes only, and should not be interpreted as a limitation. Instead, the non-linear and linear convergences each can be reduced to any suitable mathematical processes without departing from the spirit of the invention.

Referring to FIG. 2, a sequence of periodic source signals V_{sync} is demonstratively drawn against time t. For simplicity and demonstration purposes, only six signals are presented. In general, the source signals V_{sync} may comprise any number of signals. A sequence of periodic reference synchronization signals from the master synchronization module is demonstratively illustrated therein. Still for simplicity purposes, it is assumed that the reference synchronization signals M_{sync} have the same period as the source signals but are not synchronized to the source signals of V_{sync}, and the phase-difference, represented by Φ, is defined as illustrated in the figure. With such assumption, the ratio N/D in equation 1 is 1 (one). In general, the ratio can be of any value depending upon the periods of the source signals and reference signals and system requirements.

When the phase-difference Φ is small (e.g. qualifies as a small phase-difference according to a predetermined criterion, such as three tenths or less, two tenths or less, and one tenth or less of the period of the source signal sequence V_{sync}) the reference synchronization signals M_{sync} are converged to the source signals M_{sync} using proportional feedback. The proportional feedback convergence can be mathematically expressed as:

$${M}_{sync} ( i + 1 ) = {M}_{sync} ( i ) + \frac{N}{D} T - k ⨯ Φ \qquad ( Eq . 2 )$$

wherein M_{sync}(i+1) is the timestamp of the scheduled next reference signal to be synchronized with the source signal. M_{sync}(i) is the timestamp of the most recent reference signal event. Given the assumption that the reference signals and source signals have the same frequency (period), the ratio of N/D is 1 (one). Φ is the initial phase-difference (e.g. the phase difference at time t). k is a constant that determines the phase-convergence speed. k is preferably between 0 and 1. Of course, k can be of other desired values. As a way of example, when k is 0.5, the phase difference between the reference signal and reference signals converges exponentially over time. Specifically, the phase difference is reduced by half after each scheduling until the phase-difference is infinitesimally small. In terms of the phase-difference, the above convergence process can be illustrated as:
Φ[i+1)]=(1−k)Φ[i], and |Φ(tₒ)|<ε (Eq. 3)
while ε is a predetermined threshold. A typical value of ε can be three tenths or less, two tenths or less, and one tenth or less of the period of the source signal sequence V_{sync} and n is an integer. The above convergence process is schematically illustrated in FIG. 4.

Referring to FIG. 4, the phase-difference is drawn against the source signal V_{sync}. Curve AB represents the non-liner convergence process as discussed above, wherein the initial phase-difference Φ_{A} is small, such as Φ_{A}<ε.

The convergence process with the mathematical description of equation 2 has other variations. For example, another error correction term can be appended to the equation 2 to guarantee the convergence of M_{sync} and V_{sync}.

When the phase-difference Φ is not small (as quantitatively described above), for example, larger than the predetermined threshold ε, a convergence process complying with equations 2 and 3 may not be appropriate especially when the synchronization process is expected to be smooth without perceptible abrupt change. A typical instance of such is the synchronization of a motor to the source signal V_{sync}. Motors posses significant rotational inertia. Abrupt changes in their speeds during operation are highly unfavorable. Therefore, a synchronization process with smooth convergence is desirable.

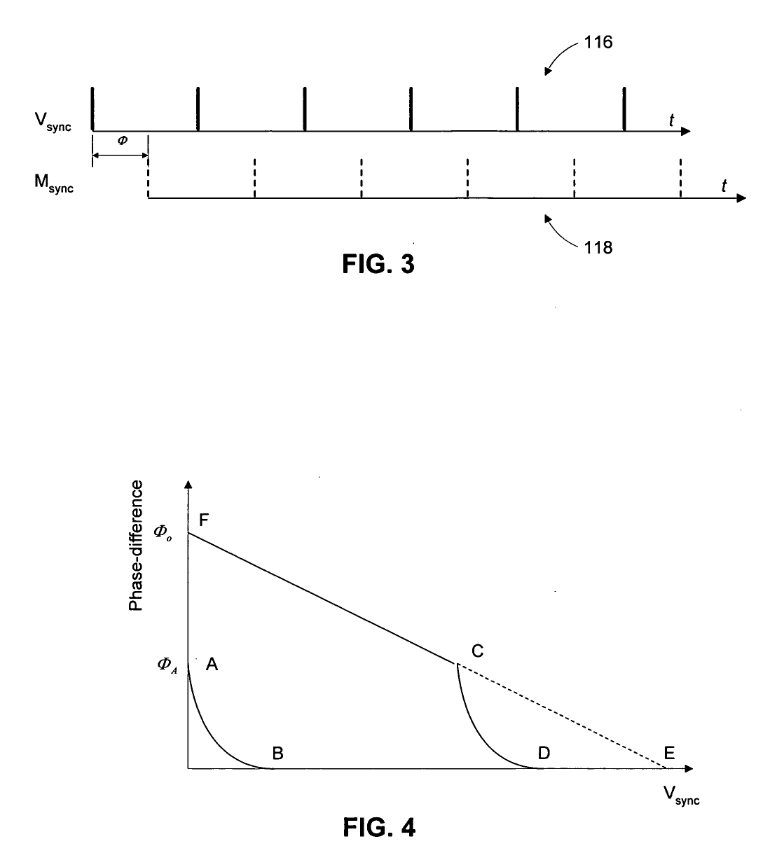

FIG. 3 illustrates a synchronization process where the phase-difference Φ is not small as compared to ε defined above. In an extreme instance, the phase-difference Φ is 180° degrees behind of the source signal V_{sync}. To synchronize the reference signals M_{sync} to the source signals V_{sync} in a as smooth as possible way, a linear phase slew process can be employed, wherein the process can be expressed mathematically as:

$${M}_{sync} ( i + 1 ) = {M}_{sync} + \frac{N}{D} T ( l + g ) \qquad ( Eq . 4 )$$

wherein g is a constant that controls the phase-convergence speed. It is preferred that g is less than 1, more preferably less 0.5, and more preferably less than 0.05. Given the assumption that the reference signals and source signals have the same frequency (period), the ratio N/D is reduced to 1 (one). In general, the ratio can be of any other values depending upon the periods (frequencies) of the reference signals and source signals.

It can be seen that equation 4 is not a explicit function of the initial phase difference Φ. That is, scheduling of the next reference event i+1 does not depend upon the phase-difference. Instead, the next reference signal event (i+1) is scheduled such that the period of the reference signals is elongated over time as compared to the period of the source signals, which results in the reference signals phase slewing towards synchronization with the source signals. This leaner phase-convergence process is schematically drawn in FIG. 4. Refereeing to FIG. 4, initial phase-difference Φₒ is larger than ε. The convergence process as discussed above is illustrated as line FC and CE.

Alternative to the exemplary linear phase-convergence process as discussed above, a convergence process that comprises a linear and non-linear phase-convergence process can be employed. The trajectory of such the combination process can be illustrated as line FC and curve CD in FIG. 4. Specifically, when the initial phase-difference Φₒ is not small (i.e. Φₒ>ε), a linear phase convergence process complying with equation 3 is employed till C, wherein the phase-difference between the reference signal M_{sync} and source signal V_{sync} is small (i.e. Φₒ≦ε). Then the synchronization is performed with the non-linear phase convergence process, as the trajectory shifts from linear FC to non-linear curve CD in the figure. This combined process expedites the convergence, however, without sacrificing the perceived smoothness of the convergence process.

The synchronization methods discussed above is applicable to many signal processing systems, one of which is digital display systems that process source video signal form one form to another format complying with the system specification, and reproduce the video signals in display targets. Examples of such display systems are Liquid-crystals, CCD, Liquid-crystal on silicon systems, Plasma based systems, and micromirror-based display systems. In the following, exemplary applications of the synchronization process of the invention will be discussed with reference to display systems wherein the image engine of the display system is a spatial light modulator comprising an array of reflective deflectable micromirrors. It will be appreciated by those skilled in the art that the following discussion is for demonstration purposes only, and is not intended to be a limitation to the scope of the present invention.

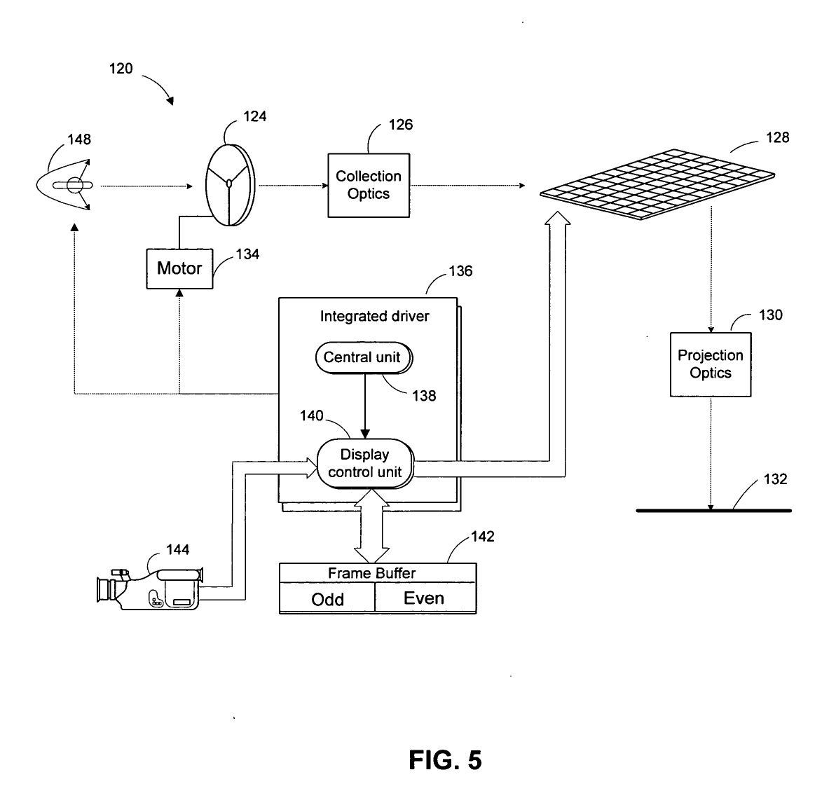

Referring to FIG. 5, display system 120 comprises light source 148, color wheel 124 that is driven by motor 134, collection optics 126, spatial light modulator 128, projection optics 130, display target 132, integrated driver 136, source signals 144, and frame buffer 142. The light source produces a light beam, which can be a white light. Exemplary light source is arc lamp, preferably an arc lamp with short arcs. The color wheel comprises a set of color segments for producing colors (e.g. red, green, blue, or yellow, cyan, and magenta) by sequentially passing light beams through the color segments. This sequentially passing the segments through the light beam is accomplished by rotating the color wheel using color wheel motor 134. The monochromatic colors from the color wheel are directed to spatial light modulator 128 and sequentially illuminate the spatial light modulator.

The spatial light modulator is often referred to as an image engine that can be of any type, such as LCD, CCD, LCOS, plasma and micromirror array. Regardless of the different nature, the spatial light modulator modulates each monochromatic color incident thereto according to the image data associated with the monochromatic color. The modulated monochromatic colors are collected and projected to display target 132 by optics 130. The image data is derived from source signals 144 that can be video cameras, DVD/VCD players, TV/HDTV tuners, or PC video cards. The source signals can be of any suitable video data formats, such as standard pixel-by-pixel data format or analog video signals. Such video data is transformed into the image data, such as bitplane data by display control unit 140 of integrated driver 136, as set forth in U.S. patent application Ser. No. 10/648,608 filed Aug. 25, 2003, the subject matter being incorporated herein by reference. The transformed image data can be saved in frame buffer 142 that may comprise and odd and even sections, where the image data of the odd and even numbered pixels in a row of the pixel array are respectively stored. Central control unit 138 of the integrated driver is designated to initialize the other functional modules of the display system. Typical operations of the central control unit comprises loading the default parameters and delivers those default parameters to an image signal processor of the image data processing unit in the integrated driver; and synchronizing the components, such as the color filter and the light source of the display system. After the initialization, the central control unit instructs the image data processing unit to receive image data of a standard format and processes the received data into bitplane data. Specifically, image signal processor of the image data processing unit retrieves data of images or videos from image source and converts the retrieved image data into bitplane data. For example, the image source provides standard RGB data of videos. The image signal processor retrieves the RGB data and applies a series of predefined data processes, such as, PWM encoding and transpose to the retrieved RGB data. The transpose operation converts the pixel data of the videos into bitplane data according to the configuration of the memory cells and wordlines, as set forth in U.S. patent application Ser. No. 10/407,061 filed Apr. 2, 2003, Ser. No. 10/607,687 filed Jun. 23, 2003, Ser. No. 10/648,608 filed Aug. 25, 2003, Ser. No. 10/648,689 field Aug. 25, 2003, Ser. No. 10/698,290 filed Aug. 25, 2003, Ser. No. 10/751,145 filed Jan. 2, 2004, Ser. No. 10/865,993 filed Jun. 11, 2004, the subject matter of each being incorporated herein by reference.

To successfully produce the video on the display target, operations of the color wheel, the light source, and modulation of the spatial light modulator need to be synchronized to the source video signals 144. Such synchronization is expected to satisfy particular requirements. First, the synchronization is expected to be capable of handling source signals V_{sync} of abnormal behaviors, such as missing of the source signals (e.g. V_{sync}=void), source signals of improper frequencies, and source signals containing abrupt phase discontinuities. Phase discontinuity may occur when for example, a user changes channel in watching a TV/HDTV when the video source is TV/HDTV, or when the noise is significant, or signal jittery when the signal strength of the signal source transmitter is far away from the receiver such that the noise is significant as compared to the strength of the video signals. The synchronization is also expected to be flexible and programmable to be easily adapted to different operational environments. The synchronization is further expected to be capable of handling synchronizations between multiple signals to the source signals, where the multiple signals may vary in frequencies and/or phases over the source signals.

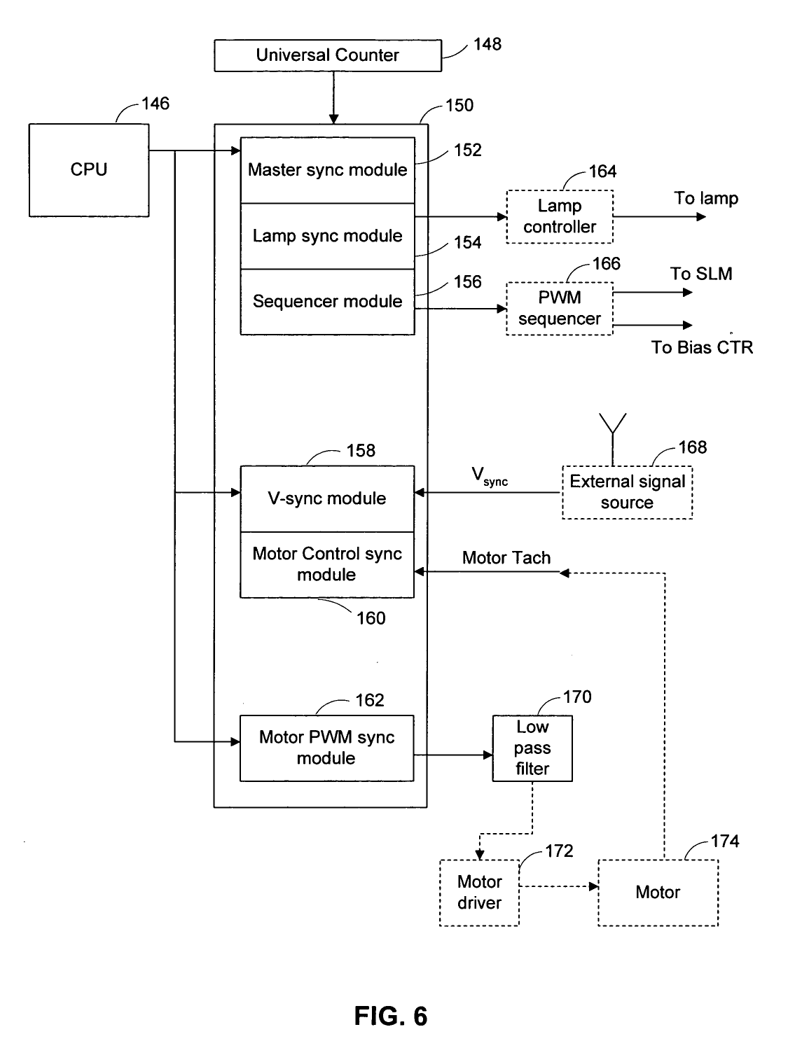

The synchronizations between the functional components of the system, such as the color wheel driver, spatial light modulator, and other components such as the lamp to the source video signals V_{sync} can be accomplished by interrupt requests (hereafter referred to as interrupts) and interrupts related generators/modules. The interrupts modules can be implemented as software modules, or in hardware. FIG. 6 schematically illustrates the hardware structure of the interrupt modules for performing the synchronization according to the invention.

Referring to FIG. 6, central-processing-unit (CPU) 146 is provided to control the interrupts modules that comprise: mater sync module 152, lamp sync module 154, sequencer module 156, V-sync module 158, motor control module 160, and motor PWM sync module 162. Universal time-base counter 148 communicates with the interrupt modules and the CPU to provide a universal time-base showed by the interrupt modules.

The V-sync module 158 is designated for capturing the source synchronization signals in the video signals delivered from the signal source 168 (e.g. the signal source 144 in FIG. 5). The master sync module (152) generates a sequence of master synchronization signals M_{sync} (also refereed to as the reference synchronization signals) and synchronizes the master synchronization signals to the received source V_{sync} signals. Other interrupt modules, such as the lamp sync module, sequencer sync module, and motor PWM sync module are synchronized with the master synchronization signals M_{sync}. Lamp sync module 154 is provided to control the light source (lamp) through lamp controller 164. Sequence module 156 is responsible for trigger the operation of pulse-width-modulation sequencer 166 that generates a signal for controlling the operations of the spatial light modulator (e.g. spatial light modulator 128 in FIG. 5) and another signal for controlling the bias voltage to be applied to the spatial light modulator. Exemplary configuration and operations of the spatial light modulator and the bias voltages of the spatial light modulators are set forth in U.S. patent application Ser. No. 10/407,061 filed Apr. 2, 2003, Ser. No. 10/607,687 filed Jun. 23, 2003, Ser. No. 10/648,608 filed Aug. 25, 2003, Ser. No. 10/648,689 field Aug. 25, 2003, Ser. No. 10/698,290 filed Aug. 25, 2003, Ser. No. 10/751,145 filed Jan. 2, 2004, Ser. No. 10/865,993 filed Jun. 11, 2004, the subject matter of each being incorporated herein by reference.

Motor PWM sync module 162 is designated for controlling the operations of the color wheel motor 174 (e.g. the color wheel motor 134 in FIG. 5). The controlling can be accomplished through low-pass filter 170 and motor driver 172. Specifically, a sequence of digitized pulse-width-modulation signals with a specific duty ratio is delivered to the low-pass filter where the digitized pulse-width-modulation signals are transformed into analog signals of amplitude corresponding to the duty ratio of the digitized pulse-width-modulation signals. The analog signal may or may not be amplified through an amplifier (not shown in the figure) and then are delivered to motor driver 172. The motor driver drives the motor with a current or voltage corresponding to the amplitude of the analog signal. When the speed of the motor rotation is to be changed (e.g. increased or decreased), the duty ratio of the digitized pulse-width-modulation signals are changed such that after the low-pass filter, the amplitude of the analog signal is accordingly changed.

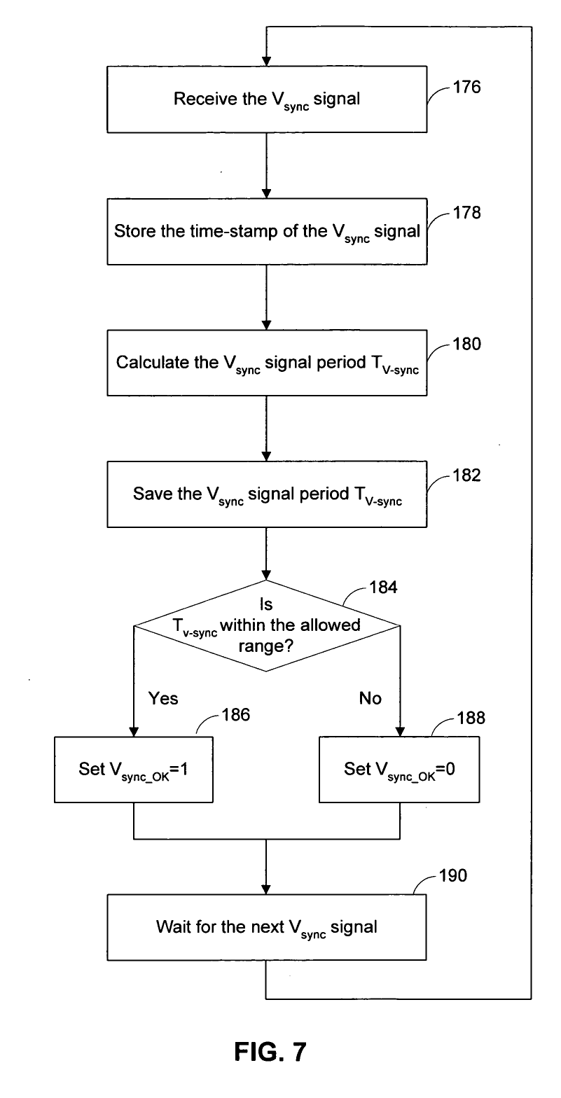

Rotation status (e.g. the speed and/or the phase) of motor 174 is dynamically detected (e.g. by a photo-detector disposed at a location proximate to the color wheel or embedded in the spatial light modulator); and the detected status of the motor is feedback to motor control sync module 160 where the status information (e.g. motor tach) is analyzed, and in turn, is used for controlling the rotation of the motor. Detailed operations of the interrupt modules will be discussed in the following with reference to FIG. 7 to FIG. 12.

Referring to FIG. 7, an exemplary operation of V-sync module 158 is illustrated therein in a flow chart. The V-sync module captures a source signal V_{sync} (step 176), extracts the timestamp from the captured source signal V_{sync} and stores the extracted timestamp (step 178). The source signal period T_{V-sync} is calculated based upon the extracted timestamp from the currently captured source signal V_{sync} and the timestamp from the immediate proceeding source signal (step 180). The period T_{V-sync} is then saved (step 182). The calculated period T_{V-sync} is then inspected (step 184) by determining whether the period T_{V-sync} is within the allowed range of the display system. If the period T_{V-sync} is within the allowed range, the received video signals are acceptable to be processed by the system, and a flag V_{sync}_{_{—}}_{OK} is set to a value (e.g. “1”) representing such validity (step 186). Otherwise, the system is not able to process the received video signals, and the flag V_{sync}_{_{—}}_{OK} is set to a value (e.g. “0”) representing such invalidity (step 188). After setting the flag V_{sync}_{_{—}}_{OK} at step 186 or 188, the V_sync module (158 in FIG. 6) is set to wait for the next source signal of V_{sync} (step 190), and the flow chart loops back to step 176 upon arrival of the next source signal V_{sync}.

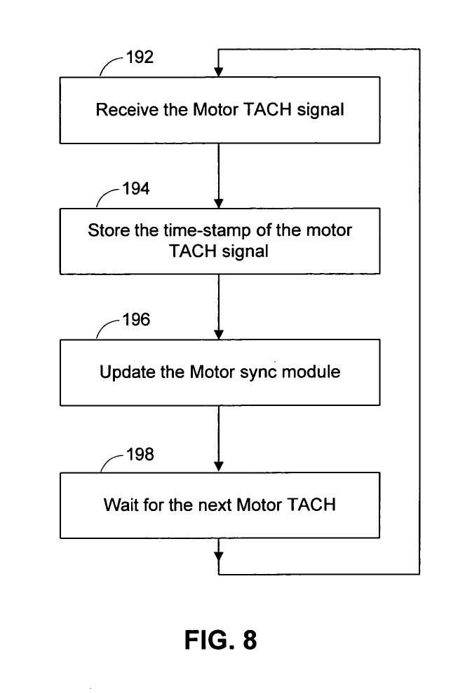

An exemplary operation of Motor control sync module 160 in FIG. 6 is illustrated in a flow chart in FIG. 8. Referring to FIG. 8, the motor control sync module monitors the status of the motor by real-timely detecting a signal (e.g. motor TACH signal) from the motor. Upon receiving such signal (step 192), the motor control sync module stores the timestamp of the signal motor TACH (step 194), followed by updating the motor PWM sync module (162 in FIG. 6). After the update, the motor control sync module waits for the next motor TACH signal (step 198). Upon receiving the next motor TACH signal, the flow chart loops back to step 192.

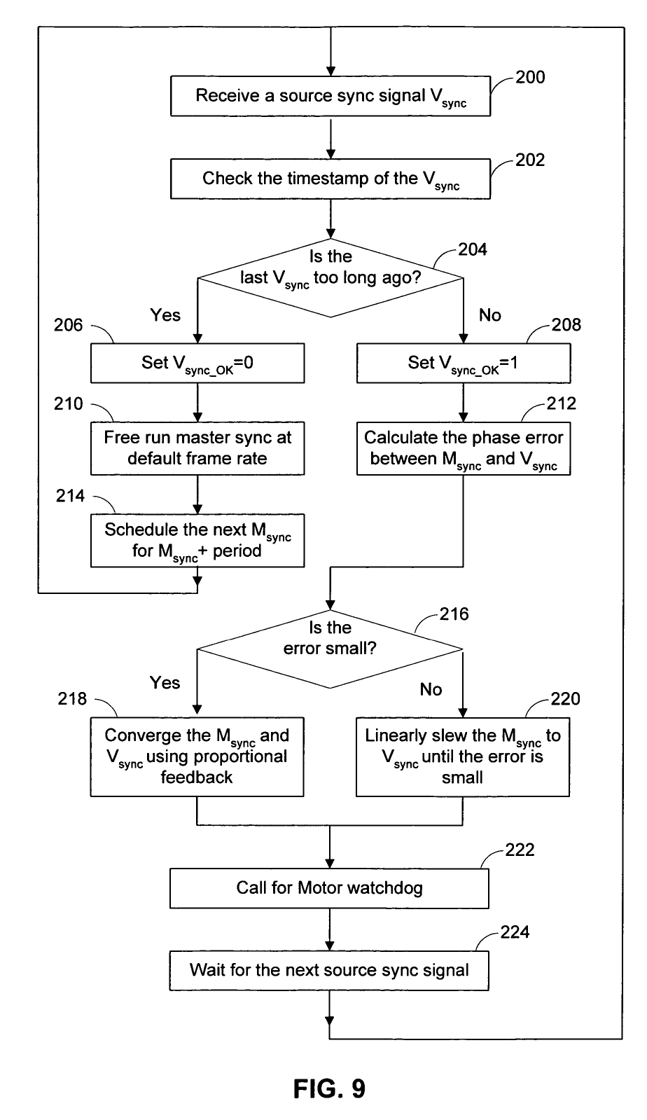

Referring back to FIG. 6, the V_{sync} module 158 receives a source signal V_{sync} as described with reference to FIG. 7. This source signal V_{sync} is transmitted to master sync module 152. The master sync module then synchronizes the master synchronization signals M_{sync} by appropriately scheduling the following master synchronization signals. An exemplary operation of the mater sync module is illustrated in a flow chart in FIG. 9.

Referring to FIG. 9, upon receiving the source signal V_{sync} (e.g. from V_sync module 158 in FIG. 6) at step 200, the timestamp of the source signal V_{sync} is checked (step 202) followed by a determination of whether the last V_{sync} is “too long time ago” (step 204). This step is accomplished by comparing the time interval between the timestamps of the currently captured source signal V_{sync=} and the last captured source signal with a predetermine time threshold, such as two frames period or longer, and three frame period or longer. If the time interval between the currently and last captured source signals is longer than the time threshold, the source signal is interpreted as being absent. The flag of V_{sync}_{_{—}}_{OK} is then set to a value (e.g. “0”) representing the absence of the source signal V_{sync} (step 206). Because of the absence of the source signals, the master sync module runs at a default rate in generating master synchronization signals for the other modules to be synchronized (step 210). Then the next master synchronization signal M_{sync} is scheduled (step 214) at the current time plus the default period of the master synchronization signals. The flow chart returns back to step 200.

If the step 204 determines that the last source signal V_{sync} is not “too long time ago”, the source signal is present and continuous (step 208), therefore is a valid and processable source (video) signal. The flag V_{sync}_{_{—}}_{OK} is set to a value (e.g. “1”) to represent such presence and continuity.

After it being determined that the received source signals are valid and processable video signals, operations of the functional components, such as the lamp, color wheel, and spatial light modulator and/or other components are synchronized with the source signals. This synchronization can be accomplished through a master synchronization signal as discussed in proceeding sections with reference to FIGS. 1 to 4. Specifically, the phase-difference Φ between the most recent master synchronization signal M_{sync} and the currently captured source signal V_{sync} is calculated at step 212. This phase-difference is compared to a predetermined threshold ε to determine whether the phase-difference is “small” or not (step 216). As discussed previously, the threshold ε is a predetermined value and can be three tenths or lower, or two tenths or lower, or one tenth or lower. If the step 216 yields that the phase-difference is small (i.e. Φ≦ε), the master synchronization signals M_{sync} are synchronized to the source signals V_{sync} using proportional feedback (step 218), by scheduling the next master synchronization signal as equation 2.

If the determination step 216 determines that the phase-difference is not “small”, that is Φ>ε), the master synchronization signals M_{sync} are synchronized to the source signals V_{sync} using a linear convergence routine (step 220), specifically by scheduling the following master signals as equation 4.

After synchronizing the master synchronization signals to the source signals at step 218 or 220, a “watchdog” function is invoked to detecting the status of the motor (e.g. motor 134 in FIG. 5). (step 222) followed by waiting for the next source signal V_{sync} (step 224). Upon receiving the next source signal V_{sync}, the flow chart starts repeats from step 200.

Given the synchronized master synchronization signals M_{sync}, interrupt modules lamp sync module 154, sequencer module 156, and motor PWM module 162 are synchronized to the master synchronization signals M_{sync} as will be detailed in the following.

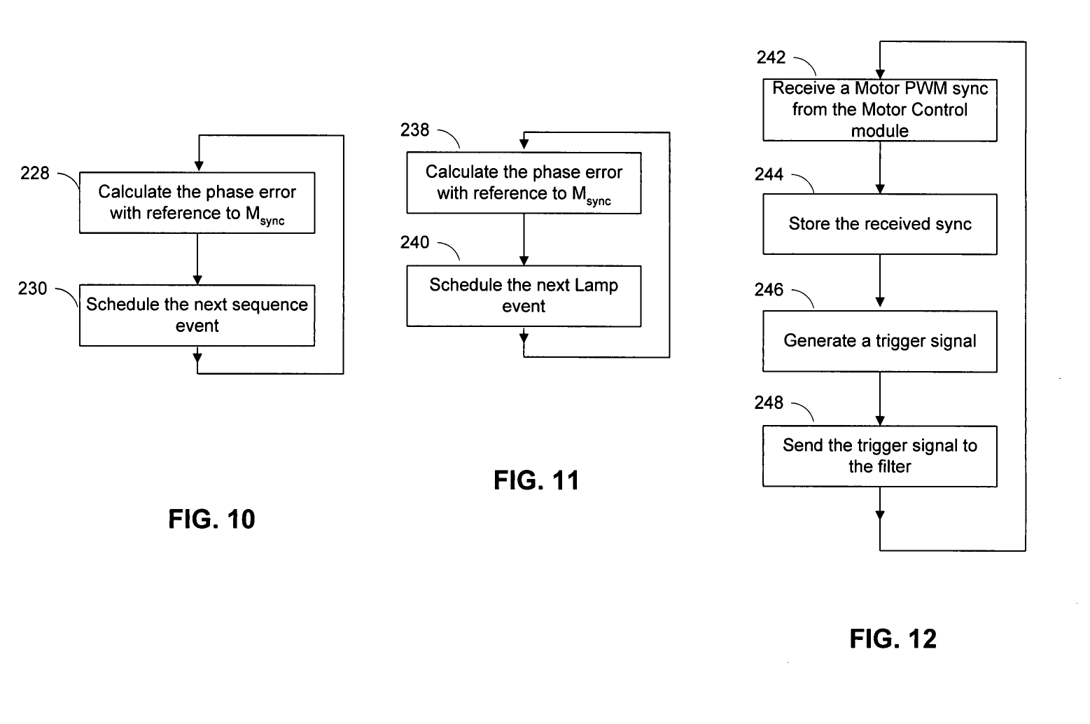

An exemplary operation of sequencer module 156 is illustrated in a flow chart in FIG. 10. Referring to FIG. 10, the phase-difference between the current sequencing synchronization signal SEQ_{sync} and the corresponding master synchronization signal M_{sync} is calculated (step 228) based upon the timestamps of the SEQ_{sync} and M_{sync}. Then the next sequencing event is scheduled as (step 230):
SEQ_{sync}(next)=SEQ_{sync}(current)+period of M_{sync}−phase-difference
The sequencing event can be an event that initializes Pulse-Width-Modulation (PWM) sequencer 166 to start the delivery process of the image data (e.g. bitplane data) generated by a pulse-width-modulation technique and to the pixels of the spatial light modulator and bias voltages to the bias controller that controls the bias voltages of the pixels in the spatial light modulator, as shown in FIG. 6.

An exemplary operation procedure of lamp sync module 154 is illustrated in a flow chart in FIG. 11. Referring to FIG. 11, a phase-difference between the current lamp synchronization signal LAMP_{sync} and the corresponding master synchronization signal M_{sync} is calculated (step 238) based upon the timestamps of the LAMP_{sync} and M_{sync}. Then the next lamp event is then scheduled as (step 240):
LAMP_{sync}(next)=LAMP_{sync}(current)+period of M_{sync}−phase-difference
The lamp event can be an event that initializes lamp controller 164 (in FIG. 6) to control the operation of the light source (e.g. light source 148 in FIG. 5).

An exemplary operation procedure of Motor PWM sync 162 in FIG. 6 is illustrated in a flow chart in FIG. 12. Upon receiving a control signal from the motor control sync module 160 (step 242), the control signal is stored at step 244. Then a trigger signal is generated (step 246) and sent out for controlling the operations of the motor (step 248). The trigger signal can be delivered to low-pass filter 170 in FIG. 6 that transforms a sequence of digitized PWM signals with specific frequency (or frequencies) into an analog signal. The transformed analog signal may or may not be amplified, and is transmitted to motor driver 172 (FIG. 6) for driving the motor (e.g. motor 174 in FIG. 6) to rotate at a speed determined by the amplitude of the analog signal.

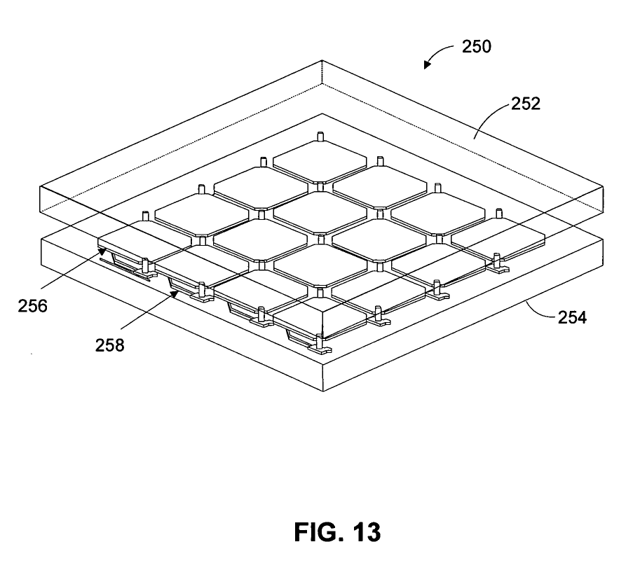

The synchronization methods as discussed above are applicable to many signal processing systems, one type of which is digital display systems. A type of digital display system is systems wherein the spatial light modulators are micromirror-based spatial light modulators, as set forth in U.S. Pat. No. 5,835,256 issued Nov. 10, 2003, U.S. patent application Ser. No. 09/767,632 filed Jan. 22, 2001, Ser. No. 10/437,776 filed May 13, 2003, Ser. No. 10/698,563 filed Oct. 30, 2003, Ser. No. 10/982,259 filed Nov. 5, 2004, the subject matter of each being incorporated herein by reference. As a way of example, FIG. 13 illustrates a perspective view of an exemplary spatial light modulator comprising an array of deflectable reflective micromirrors. For demonstration and simplicity purposes, only 4×4 micromirrors are illustrated. However, the spatial light modulator may comprise any number of micromirrors, such as 1024×768, 1280×720, 1400×1050, 1600×1200, 1920×1080, or even larger number of micromirrors. In other applications, the micromirror array may have less number of micromirrors.

Referring to FIG. 13, an array of deflectable reflective mirror plates 256 is disposed between substrate 252 and substrate 254. Substrate 252 can be a light transmissive substrate such as glass, quartz, and sapphire, and substrate 254 can be a standard semiconductor substrate where standard integrated circuits can be formed thereon. An array of addressing electrodes 258 is disposed proximate to the mirror plate array for individually addressing and deflecting the mirror plates. The mirror plates can be formed on substrate 252 or alternatively on substrate 254. When the mirror plates are formed on substrate 254, substrate 252 may not be necessary.

In another example, the mirror plates may be derived from a single crystal, such as a single crystal silicon, while other components of the micromirror, such as the deformable hinge to which the mirror plate is attached so as to enabling the deflection of the mirror plate, may or may not be derived from the single crystal.

The micromirrors in the array can be arranged in many suitable ways. For example, the micromirrors can be arranged such that the center-to-center distance between the adjacent mirror plates can be 10.16 microns or less, such as 4.38 to 10.16 microns. The nearest distance between the edges of the mirror plate can be from 0.1 to 1.5 microns, such as from 0.15 to 0.45 micron, as set forth in U.S. patent application Ser. No. 10/627,302, Ser. No. 10/627,155, and Ser. No. 10/627,303, both to Patel, filed Jul. 24, 2003, the subject matter of each being incorporated herein by reference.

It will be appreciated by those of skill in the art that a new and useful method and apparatus of signal synchronization have been described herein. In view of many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

We claim:

1. A method of synchronizing a sequence of reference signals to a sequence of source signals, the method comprising:
determining an initial phase-difference between a reference signal of the sequence of reference signals and a source signal of the sequence of source signals; and
synchronizing the reference signals to the source signals with a synchronization scheme depending upon the determined initial phase-difference, wherein the synchronization scheme has the capability of being a linear or a non-linear synchronization scheme.

2. The method of claim 1, wherein the step of synchronizing the reference signals further comprises:
sequentially scheduling the reference signals such that the phase-difference between the reference signals and source signals decreases non-linearly over time when the synchronization scheme is non-linear; and
sequentially scheduling the reference signals such that the phase-difference between the reference signals and source signals decreases linearly over time when the synchronization scheme is linear.

3. The method of claim 2, further comprising:
comparing a magnitude of the phase-difference with a predetermined phase-difference threshold; and
if the magnitude is smaller than the phase-difference threshold, sequentially scheduling the reference signals such that the phase-difference between the reference signals and source signals decreases non-linearly over time using the non-linear synchronization scheme.

4. The method of claim 3, wherein the threshold is three tenths or less of a period of the source signals.

5. The method of claim 4, wherein the threshold is one tenth or less of a period of the source signals.

6. The method of claim 3, wherein phase-difference decreases exponentially over time.

7. The method of claim 2, further comprising:
comparing a magnitude of the phase-difference with a predetermined phase-difference threshold; and
if the magnitude is equal to or larger than the phase-difference threshold, sequentially scheduling the reference signals such that the phase-difference between the reference signals and source signals decreases linearly over time using the linear synchronization scheme.

8. The method of claim 7, wherein the step of sequentially scheduling the reference signals further comprises:
scheduling, at a time t, a next reference signal at a time of t+Δt, such that a ratio of Δt to a period of the source signals is less than 1.

9. The method of claim 7, wherein the step of sequentially scheduling the reference signals further comprises:
scheduling, at a time t, a next reference signal at a time of t+Δt, such that a ratio of Δt to a integer multiple of a period of the source signals is less than 1.

10. The method of claim 7, wherein the step of sequentially scheduling the reference signals further comprises:
scheduling, at a time t, a next reference signal at a time of t+Δt, such that a ratio of an integer multiple of Δt to a period of the source signals is less than 1.

11. The method of claim 7, wherein the step of sequentially scheduling the reference signals further comprises:
scheduling, at a time t, a next reference signal at a time of t+Δt, such that a ratio of Δt to a period of the source signals is greater than 1.

12. The method of claim 7, wherein the step of sequentially scheduling the reference signals further comprises:
scheduling, at a time t, a next reference signal at a time of t+Δt, such that a ratio of Δt to a integer multiple of a period of the source signals is greater than 1.

13. The method of claim 7 wherein the step of sequentially scheduling the reference signals further comprises:
scheduling, at a time t, a next reference signal at a time of t+Δt, such that a ratio of an integer multiple of Δt to a period of the source signals is greater than 1.

14. The method of claim 7, wherein the threshold is three tenths or less of a period of the source signals.

15. The method of claim 7, wherein the threshold is one tenth or less of a period of the source signals.

16. An apparatus for synchronizing a first sequence of signals to a sequence of source signals, comprising:

17. A system of synchronizing a sequence of reference signals to a sequence of source signals, the system comprising:
first means for determining an initial phase-difference between a reference signal of the sequence of reference signals and a source signal of the sequence of source signals; and
second means for synchronizing the reference signals to the source signals with a synchronization scheme depending upon the determined initial phase-difference, wherein the synchronization scheme has the capability of being a linear or a non-linear synchronization scheme.

18. A method of synchronizing a sequence of reference signals to a sequence of source signals using a synchronization scheme that comprises a linear phase convergence process followed by a non-linear phase convergence process, wherein the linear phase convergence process synchronizes the reference signals to the source signals such that a phase-difference between the reference signals and source signals decreases linearly over time; and wherein the non-linear phase convergence process synchronizes the reference and source signals such that the phase-difference decays non-linearly over time.

19. The method of claim 18, wherein an initial phase-difference between a reference signal and source signal at the start of the linear convergence is larger than a phase-difference threshold.

20. The method of claim 19, wherein the threshold is three tenths or less of a period of the source signals.

21. The method of claim 20, wherein the threshold is one tenth or less of a period of the source signals.

22. The method of claim 18, wherein the linear phase convergence process comprises:
scheduling, at a time t, a next reference signal at a time of t+Δt, such that a ratio of Δt to a period of the source signals is less than 1.

23. The method of claim 18, wherein the linear phase convergence process comprises:
scheduling, at a time t, a next reference signal at a time of t+Δt, such that a ratio of Δt to a integer multiple of a period of the source signals is less than 1.

24. The method of claim 18, wherein the linear phase convergence process comprises:
scheduling, at a time t, a next reference signal at a time of t+Δt, such that a ratio of an integer multiple of Δt to a period of the source signals is less than 1.

25. The method of claim 18, wherein the linear phase convergence process comprises:
scheduling, at a time t, a next reference signal at a time of t+Δt, such that a ratio of Δt to a period of the source signals is greater than 1.

26. The method of claim 18, wherein the linear phase convergence process comprises:
scheduling, at a time t, a next reference signal at a time of t+Δt, such that a ratio of Δt to a integer multiple of a period of the source signals is greater than 1.

27. The method of claim 18, wherein the linear phase convergence process comprises:
scheduling, at a time t, a next reference signal at a time of t+Δt, such that a ratio of an integer multiple of Δt to a period of the source signals is greater than 1.

28. The method of claim 18, wherein the phase-difference is smaller than a predetermined threshold at the start of the non-linear convergence process.

29. The method of claim 28, wherein the threshold is three tenths or less of a period of the source signals.

30. The method of claim 28, wherein the threshold is one tenth or less of a period of the source signals.

31. The method of claim 28, wherein the phase-difference decays exponentially.

32. A method of synchronizing a first sequence of signals to a sequence of source signals, the method comprising:
generating a sequence of reference signals;
synchronizing reference signals to the source signals; and
synchronizing the first signals to the reference signals.

33. The method of claim 32, wherein the step of synchronizing the reference signals to the source signals further comprises the steps set forth in claim 1.

34. The method of claim 32, wherein the step of synchronizing the reference signals to the source signals further comprises steps set forth in claim 18.

35. The method of claim 32, further comprising:
providing a sequence of second signals;
synchronizing the second signals to the reference signals; and
wherein the second signals are independent from the first signals.

36. The method of claim 32, wherein the reference signals are interrupt signals for a CPU of a computing device.

37. The method of claim 32, wherein the first signals are interrupt signals for a CPU of a computing device.

38. A display system comprising:
a light source;
a color wheel and a color wheel motor for driving the color wheel to produce colors;
a spatial light modulator for modulating the colors so as to produce a desired image;
a signal source receiving a sequence of video signals; and
a driver for controlling a set of modules comprising the spatial light modulator and the color wheel motor, further comprising:
a master sync module that generates a set of master synchronization signals and synchronizes the master synchronization signals to the video signals;
a motor control module that generates a motor synchronization signal and synchronizes the motor synchronization signal to the master synchronization signals; and
a motor PWM module that generates a trigger signal under an instruction of the motor control module, wherein the trigger signal triggers an operation of the color wheel motor.

39. The system of claim 38, further comprising: a central-processing-unit (CPU) that is in communication with the master sync module and driver.

40. The system of claim 39, wherein the signals are interrupt requests for the CPU.
